(19) United States
(12) Patent Application Publication
(10) Pub. No.: US 2005/0015807 A1
(43) Pub. Date: Jan. 20, 2005

(54) Network systems and methods to push video

(75) Inventor: Joel K. Young, Eden Prairie, MN (US)

Correspondence Address: Schwegman, Lundberg, Woessner & Kluth, P.A., P.O. Box 2938, Minneapolis, MN, 55402, US

(73) Assignee: Digi International Inc.

(21) Appl. No.: 10/621,227

(22) Filed: Jul. 15, 2003

(51) Int. Cl. G06F 15/16

(52) U.S. Cl. 725/86; 709/231

(57) ABSTRACT

A network video system providing centralized control of video content displayed on remotely located video displays. The system comprises at least one video display, at least one media server, at least one video file server and a web client. Each media server communicates with one or more of the video displays. Each video file server includes a number of video files that include video content to be selectively displayed on a video display. The web client communicates with each video file server through a network to configure at least one playlist in each video file server. Each playlist includes at least one identifier to select one or more of the number of video files. A video file server pushes video content from a selected video file in the video file server to a selected media server based on the playlist. Each media server translates the pushed video content into a video output signal suitable for display on the video display.

### CROSS REFERENCE TO RELATED APPLICATION

This application is related to the following commonly assigned U.S. patent application which is herein incorporated by reference in its entirety:
“Network Systems and Methods to Pull Video,” U.S. application Ser. No. ______, filed on ______, 2003.

### TECHNICAL FIELD

This document relates generally to networked data systems and in particular to a system and method of pushing video information over a data communications network.

### BACKGROUND

As video monitors become more readily available it is becoming more desirable to provide information in video format and to distribute the video information over a non-centralized area.

Some systems distribute video information by connecting video monitors or receivers to the sources of the information by point to point connections that need long dedicated cabling systems. In point to point systems, multiple analog or digital video signals are transmitted to a number of receiving stations and a tuner is used at the receiver to select the information to display. Other systems use a data communications network to distribute the video information. A network system transmits video to a remote personal computer or server that manages the display of the video content. Thus, with either a point to point system or a network system, the receiving location controls the content that is displayed.

Controlling content at the receiving location is problematic if someone needs to control the content of multiple displays from a central location. For example, if it is desired to control the display of video content on several monitors and it is desired to have a unique playlist for each monitor, the playlist on each computer or server needs to be programmed. Also, each additional receiver of video content on the system requires another remote computer which adds expense to the installation of the display at the receiver location. In many instances it may be desired to minimize the cost of the receiver installation. One way to reduce the cost is to reduce the amount of intelligence in the system at the receiver location.

What is needed is an improved method of distributing video information.

### SUMMARY

This document describes a network video system that provides centralized control of video content displayed on remotely located video displays.

The system comprises at least one video display, at least one media server, at least one video file server and a web client. Each media server communicates with one or more of the video displays. Each video file server includes a number of video files that include video content to be selectively displayed on a video display. The web client communicates with each video file server through a network to configure at least one playlist in each video file server. Each playlist includes at least one identifier to select one or more of the number of video files. A video file server pushes video content from a selected video file in the video file server to a selected media server based on the playlist. Each media server translates the pushed video content into a video output signal suitable for display on the video display.

This summary is intended to provide an overview of the subject matter of the present application. It is not intended to provide an exclusive or exhaustive explanation of the invention. The detailed description is included to provide further information about the subject matter of the present patent application.

### BRIEF DESCRIPTION OF THE DRAWINGS

In the drawings like numerals refer to like components throughout the several views.

FIG. 1 shows an embodiment of a system for pushing video content over a data communications network.

FIG. 2 shows an embodiment of a video content playlist.

FIG. 3 shows an example of a decision tree.

FIG. 4 shows another embodiment of a system for pushing video content over a data communications network.

FIG. 5 shows an embodiment of a video file server.

FIG. 6 shows an embodiment of a method of pushing video information.

### DETAILED DESCRIPTION

In the following detailed description, reference is made to the accompanying drawings which form a part hereof, and in which is shown by way of illustration specific embodiments in which the invention may be practiced. It is to be understood that other embodiments may be utilized and structural changes may be made without departing from the scope of the present invention.

This document discusses a system and method for distributing video content over a data communications network. An advantage of using a data network, is that the network is often already available, eliminating the need for a special video cabling infrastructure. Also, a data network is flexible, allowing more receivers to be added without necessarily requiring more cabling. According to various embodiments of the system, playlists for remote displays are configured from a central location. Video information is distributed to the network displays by pushing information over the network to the remote displays. The cost of the system at the receiver location is reduced because the intelligence in the system is located at the source of video files rather than at the receiver location.

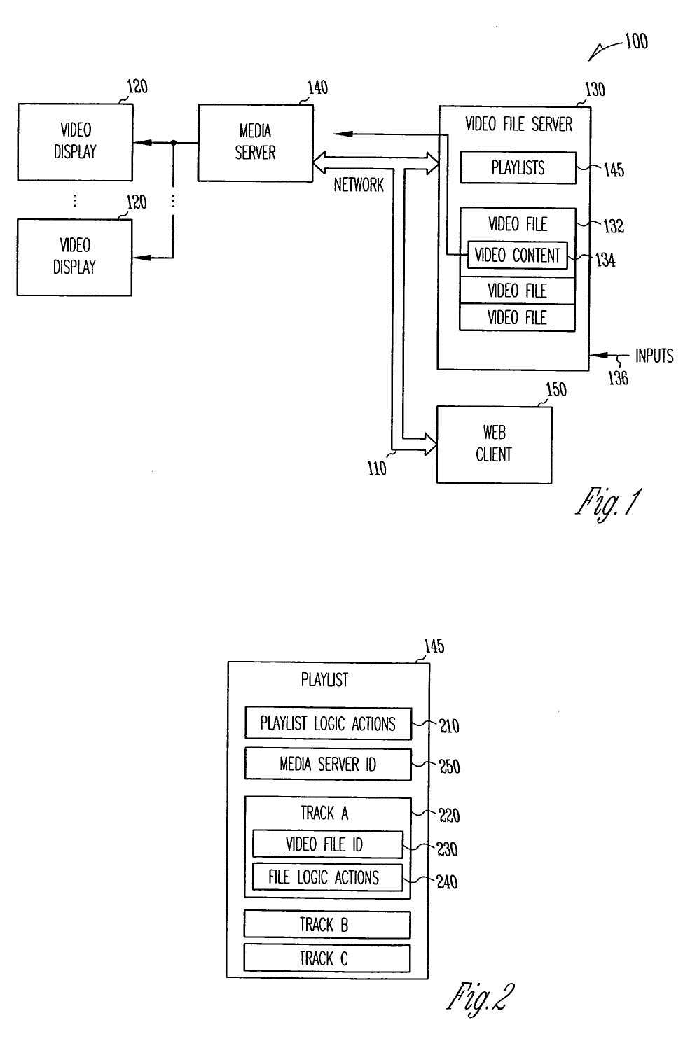

FIG. 1 shows an embodiment of a system 100 for pushing video content over a data communications network 110. The illustrated system 100 includes at least one remote video display 120, a video file server 130, a media server 140, and a web client 150 to communicate with the video file server 130 through the network 110. Various embodiments of a video display include a computer CRT (e.g. VGA, SVGA or XGA formats), a flat panel display, a digital flat panel display, a LCD projector, a television, a monitor, a high definition television (HDTV), or the like. The video file server 130 includes a number of video files 132 to provide video content 134 to be selectively displayed on the remote displays. The present subject matter is not limited to any particular video format. Various embodiments include Power Point, J-peg, a video clip format (E.g. MPX, AVI or M-peg) or a web video format (E.g. html, asp or flash). In some embodiments, the video files 132 also include audio content. Nor is the present subject matter limited to any particular network protocol. In one example of the various embodiments possible, the data network uses the transmission control protocol/Internet Protocol (TCP/IP) to transfer the video content 134.

The web client 150 communicates with the video file server 130 through the network 110 to configure a playlist 145 or sequence of playlists 145 in the video file server 130. The video file server 130 controls the presentation of video content 134 on the video display 120 by executing the playlists 145. The video file server 130 pushes digital video content 134 from a selected video file 132 to the media server 140 based on the playlists 145. The video server indicates to the media server whether the content is motion video or a fixed video image. The media server 140 translates the pushed video content 134 into a video output signal suitable for display on the video display 120. The video output signal is either analog or digital, and format options include, but are not limited to, VGA, SVGA, XGA, DVI, S-video, component video and composite video. In one embodiment, the media server 140 buffers a portion of the video file 132 in a memory as it receives video content 134. In another embodiment, the media server 140 buffers the entire file.

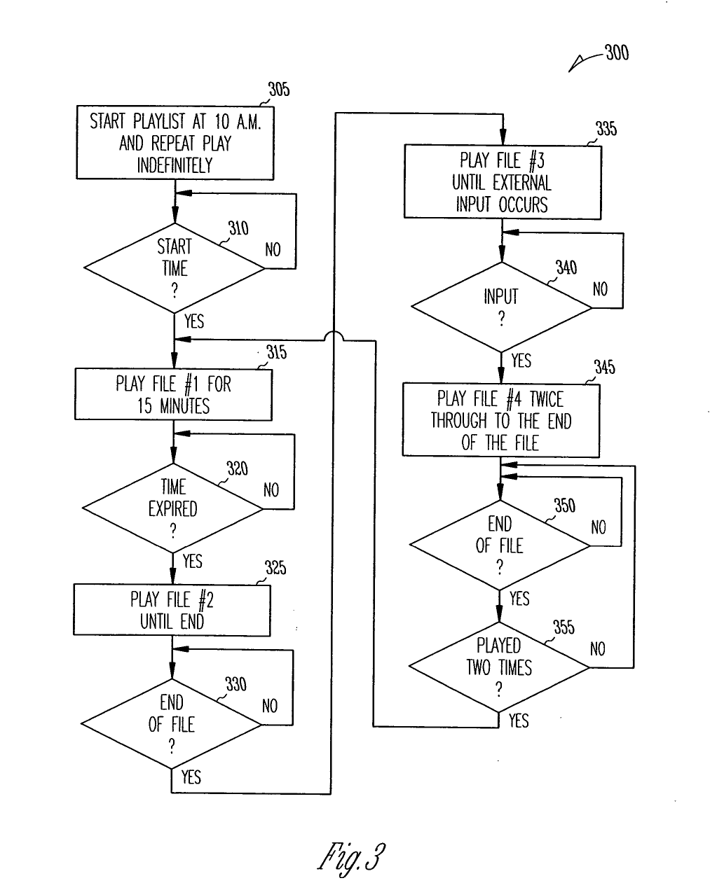

An embodiment of a playlist 145 is shown in FIG. 2. Each playlist 145 includes logic actions 210 related to playing the playlist 145. The logic actions 210 include, but are not limited to, a start time of the playlist 145, a termination time of the playlist 145, a number of times to play the playlist 145, and the sequence of files in the playlist 145. The playlist 145 includes at least one track 220, or entry, that includes an identifier 230 to select one or more video files 132 from the video file server 130. In another embodiment, the track 220 also includes logical actions 240 related to playing the video content 134 of the video files 132 indicated by the track. The logical actions 240 related to the files include, but are not limited to, the duration for playing the video content 134, a number of times to repeat playing the video content 134, or direct controls over the video presentation such as start, stop, pause and play and the like. The video file server 130 executes the playlist based on the logical actions 210, 240. The logical actions-also include actions that are application specific to the video format. For example, if the video application is a power point presentation, the logical actions include next slide or last slide. Other application specific logical actions include play, restart, rewind, fast-forward, next file, last file, mouse click, hyperlink and go to new file list. Various embodiments of the logical actions include various combinations of the types of actions listed and other actions related to the playing of video files.

In various embodiments, the video file server 130 is capable of executing in auto-mode or interactive mode or a combination of the two modes. In the auto-mode, the web client 150 configures a playlist 145 based on a sequence of logical actions 210, 240 in the form of a decision tree. Once configured the events execute on the video file server 130 independently of the web client 150. To configure the playlist, one embodiment includes a user using the web client to log into a video file page on a video file server 130 using a web browser and selecting files in the video file server 130 for the playlist by pointing to the files with a mouse. The logic actions are then entered using the web client 150 to control the display of the video content. Once configured, the actions execute independent of the web client 150 similar to a batch mode. The decisions in the tree include criteria internal to the video file server 130 such as time of day, play duration, video file 132 and/or playlist order sequence, and also include inputs originating external to the video file server 130. The decisions in the tree determine the progression the through the playlist 145. These decisions include a decision to begin playing a file or playlist, to pause a file or playlist, to continue playing a paused a file or playlist, or to jump or branch to a new sequence of files. In one embodiment, a playlist 145 is stored in the video file server 130 for future access.

External inputs are received over the network 110 or other port 136 on the video file server 130. In one embodiment, an external input is received over the network 110 from the web client. In another embodiment, an external input is a prompt such as a button press or a mouse click.

The external inputs are decoded and mapped to the application specific commands. For example, a mouse input could be mapped to a mouse click to begin, continue, or jump to a presentation for a power point application, or the mouse input could be mapped into a play command for an M-peg application. Also, an external input is able to determine a sequence of play in a playlist 145. For example, if video file A is currently playing, an occurrence of an external input determines if video file B or video file C is played next. In another example, video file A is playing and there are two external inputs, B and C, which determine the next file that plays. External input B causes video file B to play next and external input C causes video file C to be played. If the playlist 145 is interrupted at the server, the system 100 has the option to restart the playlist 145 by sending an external input from the web client 150.

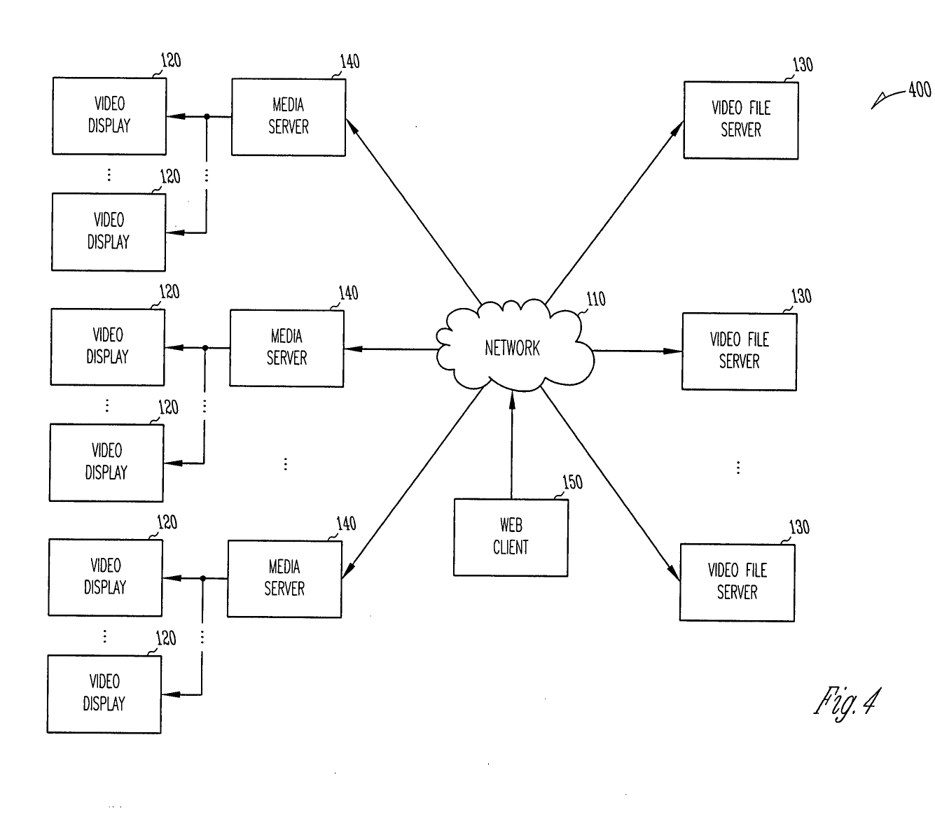

FIG. 3 shows an example of an auto-mode decision tree 300 formed from logical actions 210, 240. At 305, the playlist 145 is configured to start at ten AM and play indefinitely. At 310, the time is checked and a decision is made whether to start the playlist 145. At 315, the first video file is identified which is configured to start and play for fifteen minutes. The video file server 130 pushes the video file 132 to the media server 140 and the media server 140 begins displaying the video content 134. At 320, the playing time is checked for expiration and a decision is made whether to continue on in the playlist 145.

At 325, the second video file is identified which is configured to play until the end of the file. The video file 132 is pushed by the video file server 130 to one or more media servers 140 and at 330, the video file server 130 waits for the end of the file before proceeding in the playlist 145. At 335, the third video file is identified which is configured to play until an input external to the video file server 130 occurs. At 340, the video file server 130 waits for the external event before proceeding in the playlist 145. At 345, the fourth file is identified which is configured to play the video content 134 twice through to the end of the file. At 350, the video file server 130 waits for the end of the file. At 355, the video file server 130 checks if the file has been played twice. If not, the video file server 130 loops back in the tree 300 to play the fourth file again. If it is the second time the file was played, the video file server 130 loops back in the tree 300 to push the first video file and continue the display.

An example configuration implementing the decision tree of FIG. 3 is shown below in Table 1. The configuration shows that the video files 132 are of different types and that they are pushed to different media servers 140. The configuration also shows that playing the files continues until one of several possible events occurs.

TABLE 1
Playlist 1

| Start: 10:00:00 | | Repeat: Indefinitely | | |
|---|---|---|---|---|
| | File | Destination | Play | No. of times |
| 1. | Picture1.jpg | Mediaserver1 | 00:15:00 | 1 |
| 2. | Video1.mp1 | Mediaserver2 | Until End | 1 |
| 3. | Picture2.jpg | Mediaserver1 | Until Input | Loop |
| 4. | Video2.mp2 | Mediaserver3 | Until End | 2 |

In another embodiment of the video file server 130 executing in the auto-mode, a computer on the network plays the role of the web client 150 in configuring a playlist 145 on the video file server 130. This is done by an application on the computer downloading an existing playlist 145 from the video file server 130. Examples of such an application include a web browser and a custom application written to perform the downloading and editing. The network computer edits the playlist 145 and then uploads the new configuration to the video file server 130.

In the interactive mode, the web client 150 controls the playing of video content 134 by the video file server 130 in real time via a web interface to the network 110. In one embodiment, the web client logs into a video file page on the video file server 130 using a web browser and accesses a playlist in interactively. Play is controlled by the web client 150 executing application specific logic actions of the type discussed previously.

The video file server 130 and the media server 140 interact under two different modes of operation. The first mode is application independent mode. In this mode, a video file server includes a virtual display driver. The virtual display driver accepts video content 134 from the specific video application running locally on the video file server and converts the content 134 to digital video output before pushing the video to one or more media file servers 140. This mode is application independent because the media server 140 does not need to know the specific application that is providing the content 134. The virtual display driver appears to the video file server 130 as a video display, but the virtual display driver software is actually translating the video content 134 before the content 134 is pushed to the media server 140.

The second mode is application dependent mode. In this mode a media server 140 must know the specific application running on the video file server 130 that is providing the video content 134. Video content 134 is sent in the format of the application running on the video file server 130 (e.g. a metafile representation of a Microsoft Office™ document) and is decoded at the media server pursuant to a specific application. The media server 140 then translates the content into a video output signal suitable for display.

Application dependent mode may be more appropriate for an application where a virtual display driver encounters a large amount of file overhead. Using application dependent mode helps to resolve the overhead issue. Application independent mode does not require a media server 140 to include decoding software or hardware. This is useful if the application would benefit from a less expensive media server 140. In either mode, video content 134 is being pushed to the media server 140 for display and the video file server 130 must indicate whether the content is fixed video or includes motion video.

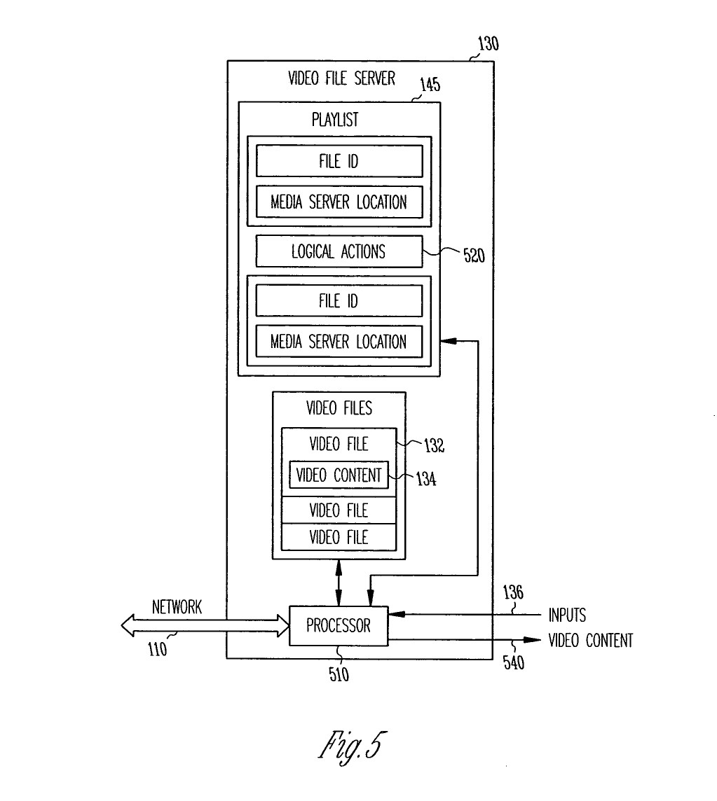

FIG. 4 shows another embodiment of a system 400 for distributing video content 134 over a data communications network 110. In the embodiment, web client 150 configures playlists 145 over a network 110 on a plurality of video file servers 130 where video files 132 reside. In the embodiment, the playlists 145 configured on the video file servers 130 include at least one identifier 250 to select one or more of the media servers 140. Video file servers 130 can exist in any physical relation to the media servers 140 as long as they can communicate by the network 110. Thus, the embodiment shows that control over a wide and varied network originates from a central location.

In one embodiment of a department store system, an employee in a department store is able to use a web client 150 to configure a video file server 130 to push video to one or media servers 140 to display video content on monitors at gas pumps outside of the store, and from the same location configure either the same or another video file server 130 to push video content to another media server 140 to display content on televisions located in an electronics department inside the store. In another embodiment that is more extreme, if the network 110 is part of a nationwide department store chain, a user in a first city could use a web client 150 to configure playlists on a video file server 130 in a second city and push video content 134 to a media server 140 located in a third city for display.

In another embodiment, the system 400 is part of a home entertainment system. Media servers 140 are located in multiple locations in a home containing a communications network 110. A playlist 145 can be configured on a video file server 130 to push video content 134 to a media server 140 in one location of the home and to push video or audio content in MP3 or WAV format, or the like, to another media server 140 in a different location in the home.

The department store system and home entertainment system are provided as examples of applications and are not intended to be an exhaustive listing of applications for the present subject matter.

In another embodiment of auto-mode, the video servers and media servers interact in a push-pull combination method. In the combination push-pull method, a playlist specifies that video files are pulled from multiple sources and pushed to various media servers. An example of a configuration implementing push-pull is shown below in Table 2. The configuration shows that the video files 132 are of different types, that they are pulled from different video servers and that they are pushed to different media servers

TABLE 2
Playlist 2

| Start: 10:00:00 | | | Repeat: Indefinitely | | No. |
|---|---|---|---|---|---|
| | File | Location | Destination | Play | of times |
| 1. | Picture1.jpg | Server1.com | Mediaserver1 | 00:15:00 | 1 |
| 2. | Video1.mpl | Server1.com | Mediaserver2 | Until End | 1 |
| 3. | Picture2.jpg | Server2.com | Mediaserver1 | Until Input | Loop |
| 4. | Video2.mp2 | Server1.com | Mediaserver3 | Until End | 2 |

140. Control of the video distribution is still centralized because a playlist 145 is still configured by a web client 150 on a video server.

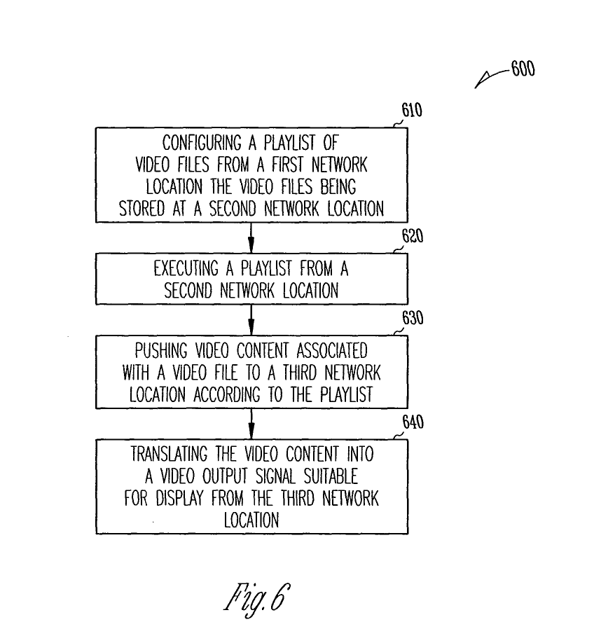

FIG. 5 shows an embodiment of a video server 130. The video server 130 comprises a processor 510, at least one playlist 145 and at least one video file 132 containing video content 134. Playlist 145 includes a list of identifiers 220 for video files 132; each video file 132 includes video content 134 to be selectively displayed and logical actions 520 related to playing the selected video content 134. The playlist 145 also includes one or more media server 140 location identifiers 230. The processor 510 executes software to transmit, or push, the selected video content 134 according to the playlist 145 and optionally to function as a virtual display driver to translate the selected video content 134 into digital video output before transmission. Inputs external to the video file server 130 are communicated over the network 110 or by another input port 136.

FIG. 6 shows an embodiment of a method 600 of distributing video information. At 610, a playlist 145 of video files 132 is configured from a first network location, such as a web client 150, and the video files are stored in at least a second network location, such as a file server 130. At 620, the playlist 145 is executed from the second network location. At 630, video content 134 associated with a video file 132 is pushed to a third network location according to the playlist. At 640, the video content 134 is translated into a video output signal 540 suitable for display from the third network location.

Although specific examples have been illustrated and described herein, it will be appreciated by those of ordinary skill in the art that any arrangement calculated to achieve the same purpose could be substituted for the specific example shown. This application is intended to cover any adaptations or variations of the present invention. Therefore, it is intended that this invention be limited only by the claims and the equivalents shown.

1. A system, comprising:
at least one video display;
at least one media server, each media server to communicate with one or more of the at least one video display;
at least one video file server, each video file server including a number of video files, each video file including video content to be selectively displayed on the at least one video display;
a web client to communicate with each video file server through a network to configure at least one playlist in the video file server, each playlist including at least one identifier to select one or more of the number of video files;
each video file server being adapted to push video content from a selected video file in the video file server to a selected media server based on the playlist; and
each media server to translate the pushed video content into a video output signal suitable for display on the video display.

2. The system of claim 1, wherein each media server further serves as a conversion agent to translate application specific pushed video content into a video output signal suitable for display.

3. The system of claim 1, wherein the video file server further includes a virtual display driver, wherein the virtual display driver serves as a conversion agent to encode the selected video content before it is sent to the at least one media server for display.

4. The system of claim 1, wherein each playlist further includes logical actions related to playing the files.

5. The system of claim 4, wherein the logical actions execute in the video file server as a decision tree.

6. The system of claim 5, wherein the video server executes the at least one playlist based on the logical actions, and wherein the logical actions are configured at least in part by the web client.

7. The system of claim 6, wherein the logical actions are configured at least in part in real time by a user using the web client.

8. The system of claim 6, wherein logical actions further include inputs external to the video file server.

9. The system of claim 4, wherein the logical actions further include a timed duration of playing the files.

10. The system of claim 4, wherein the logical actions further include a time to initiate playing the files.

11. The system of claim 4, wherein the logical actions further include a time to terminate playing the files.

12. The system of claim 4, wherein the logical actions further include a number of times to play the files.

13. The system of claim 8, wherein the inputs external to the video file server are mapped into application specific commands according to the format of the video file.

14. The system of claim 1, wherein the video file further includes audio content.

15. The system of claim 1, wherein the video content includes any combination from the set of Power Point, J-Peg, Video Clip, or Web formats.

16. A video file server, comprising:
memory to store video files and at least one playlist, each video file including video content to be selectively displayed on at least one video display, each playlist including a list of identifiers for video files, a file server location of the video files, and logical actions related to playing the selected video content; and
a processor executing application specific software to send the selected video content according to the playlist to at least one media server for display.

17. The video file server of claim 16, further comprising a virtual display driver, wherein the virtual display driver functions as a conversion agent to encode the selected video content before it is sent to the at least one media server for display.

18. The video file server of claim 16, wherein the processor executes the at least one playlist based on the logical actions and wherein the logical actions depend in part on inputs external to the video file server.

19. The video file server of claim 18, wherein the inputs external to the video file server are mapped into application specific commands depending on a format of the video file.

20. The video file server of claim 19, wherein the application specific commands include any combination from the set of Play, Restart, Pause, Stop, Rewind, Fast Forward, Next File, Next Slide, Previous Slide, Mouse Click, Hyperlink and Go To New Playlist.

21. The video file server of claim 20, wherein the inputs external to the video file server include messages received from the network.

22. The media server of claim 20, wherein the inputs external to the video file server include a prompt.

23. A method of distributing video information, comprising:
from a first network location, configuring a playlist of video files, the video files being stored in at least one second network location;
from a second location, executing a playlist, where executing includes pushing video content associated with a video file to a third network location according to the playlist; and
from the third network location, translating the video content into a video output signal suitable for display.

24. The method of claim 23, wherein executing the playlist further includes executing logical actions associated with initiation of display and termination of display of the video files.

25. The method of claim 24, wherein executing logic actions includes the second location receiving external inputs that are mapped into application specific commands.

26. The method of claim 25, wherein executing logic actions includes the second location receiving logic actions from the first location.

27. The method of claim 25, wherein the application specific commands include any combination from the set of Play, Restart, Pause, Stop, Rewind, Fast Forward, Next File, Next Slide, Previous Slide, Mouse Click, Hyperlink and Go To New Playlist.

28. The method of claim 23, wherein the first network location includes a web client.

29. The method of claim 23, wherein the second network location includes a video file server.

30. The method of claim 23, wherein the third location includes a media server.

31. The method of claim 30, wherein the first network location includes a computer and configuring a playlist includes:
downloading an existing playlist from the video file server at the second network location to the computer;
editing the playlist; and
uploading the edited playlist from the computer to the video file server.
